(19) United States
(12) Patent Application Publication
(10) Pub. No.: US 2020/0238301 A1
(43) Pub. Date: Jul. 30, 2020

(54) SYSTEM AND METHOD FOR RECOVERING METALS FROM ELECTRONIC SCRAP AND AUTO SHRED RESIDUE FINES

(71) Applicant: Thomas Valerio, Atlanta, GA (US)

(72) Inventor: Thomas Valerio, Atlanta, GA (US)

(21) Appl. No.: 15/761,417

(22) PCT Filed: Sep. 18, 2016
(86) PCT No.: PCT/US2016/052396

§ 371 Date: Mar. 19, 2018

Related U.S. Application Data
(60) Provisional application No. 62/220,717, filed on Sep. 18, 2015.

(51) Int. Cl. B03D 1/014; C22B 3/00; B03C 1/30; B03D 1/02

(52) U.S. Cl. CPC B03D 1/014; C22B 11/046; B03C 1/30; B02C 23/12; B03D 2203/025; B03C 2201/18; B03D 1/02

(57) ABSTRACT

A system and method for recovering metals from electronic scrap and auto shred residue (ASR) are described. Electronic scrap and ASR materials initially undergo size reduction processes. The reduced materials are thereafter separated according to size and magnetic properties to remove ferrous materials from the processing stream. Non-magnetic materials remaining in the processing stream are separated using oxygen encapsulated separators. The oxygen encapsulated separators strategically encounter materials to generate waste, a precious metals concentrate, and a metal concentrate.

### CROSS-REFERENCE TO RELATED APPLICATIONS

This application claims priority to and the benefit of U.S. Patent Application No. 62/220,717, filed Sep. 18, 2015, which is incorporated herein by reference in its entirety.

### TECHNICAL FIELD

This disclosure generally relates to separation techniques, and more particularly to recovering components of fine scrap materials.

### SUMMARY

This disclosure generally provides a system and method for recovering fine to ultra-fine metals from electronic scrap and auto shred residue (ASR). Electronic scrap and ASR are size reduced using crushing and grinding techniques. The reduced materials are size separated and thereafter magnetically separated to remove ferrous materials from the processing stream. Non-magnetic materials are then separated using multiple oxygen encapsulated separators. The oxygen encapsulated separators are strategically configured to produce a scavenger circuit and a cleaner circuit, which generates waste, and precious metals and metal concentrates.

### BRIEF DESCRIPTION OF THE DRAWINGS

This disclosure is illustrated in the figures of the accompanying drawings which are meant to be illustrative and not limiting, in which like references are intended to refer to like or corresponding parts, and in which:

FIG. 1 is an equipment layout diagram illustrating a material processing system accordance to the present disclosure; and

FIG. 2 is a process flow diagram illustrating a method for processing materials according to the present disclosure.

### DETAILED DESCRIPTION

Detailed embodiments of the system and method are disclosed herein, however, it is to be understood that the disclosed embodiments are merely illustrative of the system, devices, and method, which may be embodied in various forms. Therefore, specific functional details disclosed herein are not to be interpreted as limiting, but merely as a basis for the claims and as a representative basis for teaching one skilled in the art to variously employ the system, devices, and method disclosed herein.

Generally, this disclosure relates to a system and method for recovering metals from electronic scrap and auto shred residue (ASR). Electronic scrap and ASR materials undergo size reduction processes via crushing and grinding techniques. The reduced materials are thereafter size separated and magnetically separated to remove ferrous materials from the processing stream. Non-magnetic materials remaining in the processing stream are separated using oxygen encapsulated separators. The oxygen encapsulated separators strategically encounter materials to generate waste, a precious metals concentrate, and a metal concentrate.

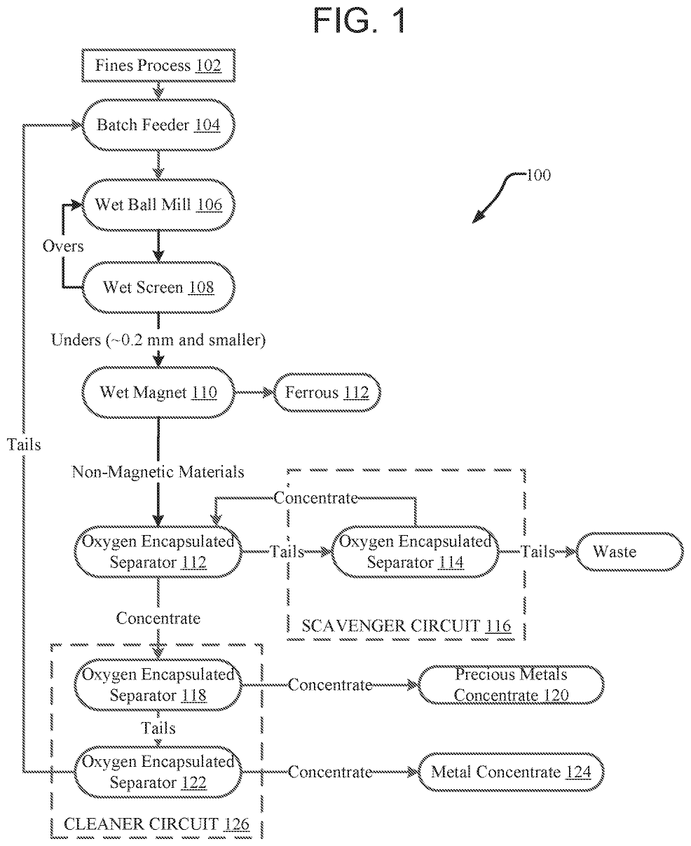

FIG. 1 illustrates a system 100 for recovering desired components of scrap materials. The system 100 receives materials that have already undergone fines processing (illustrated as 102). The received materials are transported by a batch feeder 104 to a size reducer, such as a wet ball mill 106, for example. The wet ball mill 106 crushes and grinds received materials into smaller sizes via impact/collision interactions. Both crushing and grinding lead to size reduction of the materials or to “comminution.” From example, a ball mill 106 can be used to separate high value metals from plated materials (e.g, gold from gold plated materials.) The comminuted, size reduced materials, typically below 0.2 mm, are directed to a size separator, such as a wet screen 108, that fractionates the comminuted materials by size to produce two or more sized material streams (e.g., an “overs” fraction and an “under” fraction). The wet screen 108, as its name implies, fractionates the comminuted materials using water or some other liquid. Various commercially available wet screens may be used. For example, the wet screen 108 may allow “unders” (i.e., materials about 0.2 millimeters (mm) or smaller to pass through). Materials that do not pass through the wet screen 108 (i.e., “overs,” materials about 0.2 mm and larger) are directed back to the wet ball mill 106 for further size reduction.

The “unders” (i.e., materials about 0.2 mm and smaller that pass through the wet screen 108) are directed to a wet magnet 110. The “unders” of the wet screen that are smaller than 0.2 mm are “pumped” or directed into a wet magnet 110.

At the wet magnet 110, the unders of the wet screened are separated into two fractions, a magnetic fraction (typically a ferrous metal product) and a non-magnetic fraction (with minimum ferrous metals). A drum, having magnetic properties, rotates partially within a liquid. As the drum rotates, ferrous materials 112 are attracted by the magnetic drum and are removed from the system 100. Non-magnetic materials, including non-ferrous materials, which have not removed from the system 100 by the wet magnet 110, are directed to a first oxygen encapsulated separator 112 where they are separated into a tails portion and a concentrate portion.

Oxygen encapsulated separators (OES), multiple encapsulated separators, or combinations thereof can selectively separate hydrophobic materials from hydrophilic materials with the use of a collector chemical. These chemicals will be used to target specific metal and can attach to the air bubbles generated by the oxygen encapsulated separators. The first separation targets the collection of various metals present in the slurry. Different collector chemicals can be used to “concentrate” materials having metals (such as heavy metals Cu, Zn, Pb; precious metals Au, Ag, Pd, Pt; and light metals e.g, aluminum). The metal concentrate can then be processed through a cleaner circuit 126. Currently, a large variety of organic sulfur-containing compounds, such as xanthates, dithiophosphates, dithiocarbamates, etc, are utilized as collectors in the flotation recovery of value minerals precious metal ores. Such compounds can be a free acid or any salt of the acid. Moreover, most of the collectors based on organic sulfur-containing salts are aqueous and are the sodium or potassium salts of sulfur-containing acid. Thus, when names of collectors/promotors are mentioned, such as a xanthate or dithiophosphate, it is in reference to a sodium or potassium salt.

In certain embodiments, suitable promotors include agents having the structure below.

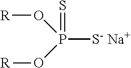

For example, a promoter may include a dithiophosphate in which R=ethyl+sec. Butyl (e.g., commercially available as AERO 208). In another example, a promoter may include a dithiophosphate in which the R-group is isobutyl (e.g., commercially available as AERO 3477).

Further, the frother can have a role in the flotation of precious and base metals. The frother's main function is to stabilize the bubbles that transport the hydrophobic value minerals to the surface froth zone where they can be more easily collected. Of particular interest is the ability of the frother to improve flotation kinetics, recovery and selectivity. As an example, the frother should allow flotation of coarse particles at high pH. In one example, the frother is polypropylene glycol frother (e.g., commercially available as F-507), which can include a blend of three or more dissimilar molecular weight to provide a wide range of tolerance to different materials and pH. This is useful in flotation cells for the flotation of coarse particles at high pH, as well as in column flotation cells.

The tails portion is directed to a second separate oxygen encapsulated separator 114 where the tails are further separated into another tails portion and a concentrate portion. Tails may be substantially free of metals (or close to free of metals). The concentrate will have any metals that were not obtained from the OES 112, such as heavy metals Cu, Zn, Pb; precious metals Au, Ag, Pd, Pt; and light metals e.g., aluminum. The tails portion generated by the second oxygen encapsulated separator 114 is removed from the system 100 as waste. While these materials are described as “waste,” one skilled in the art should appreciate that “waste” is a subjective term and that the waste materials 116, while being waste to the present system 100, may be further processed and exploited for commercial value outside of the system 100. Specially, the “waste” fraction can be considered a “non-metallic” concentrate. The concentrate portion generated by the second oxygen encapsulated separator 114 is returned to the first oxygen encapsulated separator 112 for further processing. Processing of materials by the second oxygen encapsulated separator 114 may be referred to as a scavenger circuit 116 because it provides a second processing of the tails generated by the first oxygen encapsulated separator 112 to further ensure any valuable materials remaining in the tails portion remain in the system 100 for further processing. One example of an oxygen encapsulated separator is separator or separation using froth flotation.

The concentrate of the first oxygen encapsulated separator 112 are directed to a third oxygen encapsulated separator 118, where the materials are separated into tails and concentrate portions. A precious metals (mainly, silver, gold, platinum and palladium) concentrate 120 is removed from the system 100 at the oxygen encapsulated separator 118 for further processing and/or commercial exploitation. The tails portion generated by the third oxygen encapsulated separator 118 is directed to a fourth oxygen encapsulated separator 122 where it is separated into concentrate and tails portions. The concentrate is made of the remaining metals, copper, lead, zinc, aluminum, etc.

The concentrate may need to be further treated (e.g., with other oxygen encapsulated separator) to achieve certain purity to resale each independent metal separately or as an alloy. A metal concentrate 124 is removed from the system 100 at the oxygen encapsulated separator 122 for further processing and/or commercial exploitation. The tails portion generated by the fourth oxygen encapsulated separator 122 is directed to the batch feeder 104 for further processing consistent with that described herein with respect to the system 100. Processing of materials by the third and fourth oxygen encapsulated separators 118, 122 may be referred to as a cleaner circuit 126 because the third and fourth oxygen encapsulated separators 118, 122 refine substantially metal concentrates into desired “clean” products/compositions. The “waste” from the fourth separation can be fed into the second step 104/batch feeder. The concentrate from oxygen encapsulated separator 112 is processed through the cleaner circuit which recovers precious metals 120 or metal concentrate 124. The tails of the cleaner circuit or OES 122 can be fed into the batch feeder, which may then feed ball mill 106. This step allows the tails of the cleaner circuit or OES 122 to be processed back into the system to allow further liberation of metals or further processing as waste.

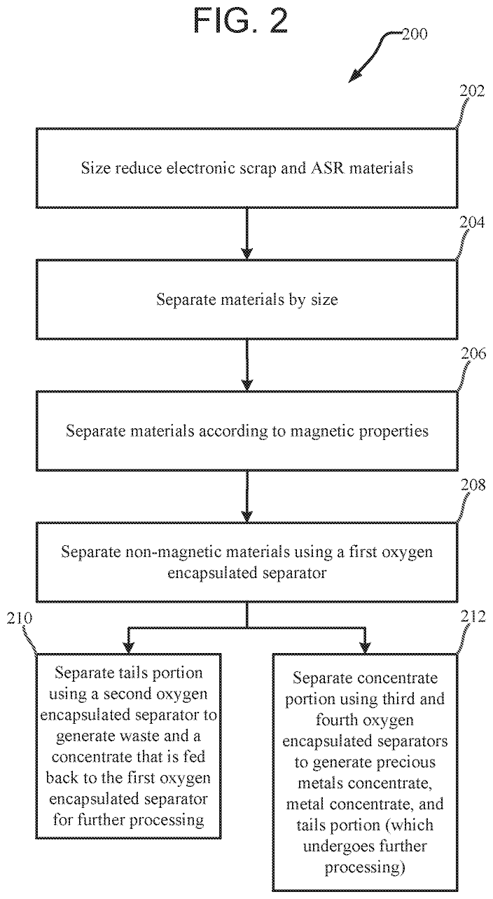

Referring now to FIG. 2, a method 200 for processing materials according to the present disclosure is described. At block 202, electronic scrap and auto shred residue (ASR) materials are reduced in size. This may be performed using a wet ball mill, for example. At block 204, the size reduced materials are separated according to size to produce at least two materials streams. For example, the materials may be sorted according to about a 0.2 mm threshold. Materials larger than about 0.2 mm may undergo further size reduction (illustrated as block 202) and subsequent size separation (illustrated as block 204).

Materials smaller than about 0.2 mm are separated according to magnetic properties (illustrated as block 206). For example, magnetic separation of the materials may occur via a wet magnet, such as the wet magnet 110 described herein. Magnetic separation of the materials may result in a ferrous composition that is removed from the processing stream (not illustrated) and a non-magnetic composition that is separated using a first oxygen encapsulated separator (illustrated as block 208). Oxygen encapsulated separators generate tails and concentrates. The tails of the first oxygen encapsulated separator are further separated using another oxygen encapsulated separator to generate a tails/waste composition (that is removed from the processing stream) and a concentrate that is further processed by the first oxygen encapsulated separator of block 208 (illustrated as block 210). The concentrate of the first oxygen encapsulated separator is further processed by at least two other oxygen encapsulated separators to produce a precious metals concentrate and a metal concentrate that are removed from the processing stream, and a tails composition that is further processed according to the method 200 described herein (illustrated as block 212). The tails of the cleaner circuit or the fourth oxygen encapsulated separator can be fed into the batch feeder, which can feed ball mill. This step allows the tails of the cleaner circuit to be processed back into the system to allow further liberation of metals or further processing as waste.

Another embodiment includes a process for recovering metals from scrap, comprising adding a first oxygen encapsulated separator and a second oxygen encapsulated separator, wherein the scrap is made into a slurry, a promoter that is dithiophasphate is added to the slurry; agitating the slurry to allow for the promoter to absorb on the metals thereby decreasing the hydrophobicity of said non-metals; and adding a frother to the slurry, the frother increases the hydrophobicity of the metals and the gas bubble distribution. The process can include recovering the metals, magnetically removing ferrous from the scrap, and sizing to scrap to a particle size less than 0.2 mm. The process may also include a third oxygen encapsulated separator and a fourth oxygen encapsulated separator.

Although specific embodiments of the disclosure have been described above in detail, the description is merely for purposes of illustration. It should be appreciated, therefore, that many aspects of the disclosure were described above by way of example only and are not intended as required or essential elements of the disclosure unless explicitly stated otherwise. Various modifications of, and equivalent steps corresponding to, the disclosed aspects of the exemplary embodiments, in addition to those described above, can be made by a person of ordinary skill in the art, having the benefit of this disclosure, without departing from the spirit and scope of the invention defined in the following claims, the scope of which is to be accorded the broadest interpretation so as to encompass such modifications and equivalent structures.

What is claimed is:

1. A method for recovering metals from scrap, comprising:
providing the scrap, wherein the scrap contains the metals,
comminuting scrap into a first residue by mechanical comminution;
sizing the first residue using a wet screen to collect a first material with a specific particle size,
magnetically separating the first material to recover ferromagnetic metals,
preparing a slurry with first material,
separating the first material using a first oxygen encapsulated separator operating with dithiophosphate, wherein there is a first heavy fraction and a first light fraction, and
separating the first light fraction using a second oxygen encapsulated separator operating with dithiophosphate, wherein there is a second heavy fraction and a second light fraction (tails).

2. The method of claim 1, wherein the specific particle size is less than 0.2 mm.

3. The method of claim 1, wherein the scrap are electronic scrap or outdated electronic devices.

4. The method of claim 1, further comprising separating the first light material using a third oxygen encapsulated separator operating with dithiophosphate, wherein there is a third heavy fraction and a third light fraction, wherein the third heavy fraction is precious metals.

5. The method of claim 1, further comprising separating the third light fraction using a fourth oxygen encapsulated separator operating with dithiophosphate, wherein there is a fourth heavy fraction, wherein the fourth heavy fraction non-precious metals.

6. The method of claim 1, wherein the dithiophosphate has the structure 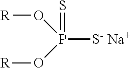
wherein the R=ethyl.

7. The method of claim 1, wherein the dithiophosphate has the structure 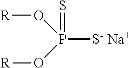
wherein the R=isobutyl.

8. The method of claim 1, further comprising a frother.

9. The method of claim 1, wherein the precious metals are gold, silver, platinum, palladium, rhodium, iridium, osmium, rhenium, ruthenium and alloys comprising same.

10. The method of claim 1, wherein the precious metals are silver gold platinum and palladium.

11. The method of claim 1, wherein the frother is polypropylene glycol.

12. The method of claim 1, further comprising directing the second heavy material to the first oxygen encapsulated separator.

13. A system for recovery metals from scrap, comprising:
a source of scrap;
A ball mill for comminuting scrap into a first residue by mechanical comminution;
a wet screen to collect a first material with a particle size of less than about 0.2 mm,
a magnet to separate the first material to recover ferromagnetic metals,
a first oxygen encapsulated separator operating with dithiophosphate, and
a second oxygen encapsulated separator operating with dithiophosphate.

14. The system of claim 13, further comprising a source of the scrap.

15. The system of claim 13, further comprising a frother.

16. A system of claim 13, further comprising:
a third oxygen encapsulated separator froth floatation operating with dithiophosphate

17. A system of claim 16, comprising:
a fourth oxygen encapsulated separator operating with dithiophosphate

18. The system of claim 17, wherein the dithiophosphate has the structure 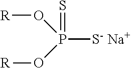
wherein the R=ethyl.

19. The system of claim 17, wherein the dithiophosphate has the structure 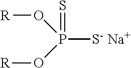
wherein the R=isobutyl.

20. A process for recovering metals from scrap, comprising
adding a first oxygen encapsulated separator and a second oxygen encapsulated separator, wherein the scrap is made in a slurry, a promoter that is dithiophasphate is added to the slurry;
agitating the slurry to allow for the promoter to absorb on the metals thereby decreasing the hydrophobicity of said non-metals; and
adding a frother to the slurry, the frother increases the hydrophobicity of the metals and the gas bubble distribution.

21. The method of claim 20, further comprising: recovering the metals.

22. The process of claim 20, further comprising:
magnetically removing ferrous from the scrap; and
sizing to scrap to a particle size less than 0.2 mm.

23. The process of claim 20, further comprising a third oxygen encapsulated separator and a fourth oxygen encapsulated separator.
